(19) United States
(12) Patent Application Publication
(10) Pub. No.: US 2024/0420293 A1
(43) Pub. Date: Dec. 19, 2024

(54) DEGRADED IMAGE FRAME CORRECTION

(71) Applicant: QUALCOMM Incorporated, San Diego, CA (US)

(72) Inventors: Deeksha Dixit, San Diego, CA (US); Varun Ravi Kumar, San Diego, CA (US); Senthil Kumar Yogamani, Headford (IE)

(21) Appl. No.: 18/336,580

(22) Filed: Jun. 16, 2023

(51) Int. Cl. G06T 5/00; G06T 7/00; G06V 10/764; G06V 10/776; G06V 20/58

(52) U.S. Cl. CPC G06T 5/77; G06T 7/0002; G06V 10/764; G06V 10/776; G06V 20/58; G06T 2207/10028; G06T 2207/10032; G06T 2207/20081; G06T 2207/20084; G06T 2207/30168; G06T 2207/30252

(57) ABSTRACT

A method of processing image data includes receiving, with a frame correction machine-learning (ML) model executing on processing circuitry, an image frame captured from a first camera of a plurality of cameras; performing, with the frame correction ML model executing on the processing circuitry, image frame correction to generate a corrected image frame based on weights or biases of the frame correction ML model applied to two or more of: samples of the image frame, samples of previously captured image frames from the first camera, or samples from image frames from other cameras of the plurality of cameras; and performing, with the processing circuitry, post-processing based on the corrected image frame.

### TECHNICAL FIELD

This disclosure relates to image frame correction in multi-camera systems.

### BACKGROUND

Techniques are being researched and developed related to autonomous driving and advanced driving assistance systems. For autonomous driving, a vehicle includes multiple cameras for capturing images from multiple perspectives. Images from the cameras are used for downstream tasks such as bird's-eye-view (BEV) image generation, object detection, and/or path planning. However, there can be instances when the images from a camera are degraded (e.g., due to faulty operation of the camera, or due to external conditions).

### SUMMARY

In general, this disclosure describes techniques for processing image data to compensate for the image degradation. As described in more detail, a frame correction machine learning (ML) model is configured to receive an image (e.g., with degradation) that is captured from a first camera of a plurality of cameras (e.g., cameras used for autonomous driving of a vehicle), and performs image frame correction to generate a corrected image frame. Input into the frame correction ML model may include samples of the image frame, samples of previously captured image frame from the camera (e.g., the camera that captured the image frame having degradation), or samples from image frames from other cameras. Processing circuitry executing the frame correction ML model may apply respective weights to the input, and output the corrected image frame. In addition, the processing circuitry may output a confidence value, indicative of confidence of accuracy of the corrected image frame. The processing circuitry may then perform post-processing (e.g., generate bird's-eye-view (BEV) image content, perform object detection, and/or perform path planning) based on the corrected image frame, and if available, the confidence value.

In one example, the disclosure describes a method of processing image data, the method comprising: receiving, with a frame correction machine-learning (ML) model executing on processing circuitry, an image frame captured from a first camera of a plurality of cameras; performing, with the frame correction ML model executing on the processing circuitry, image frame correction to generate a corrected image frame based on weights or biases of the frame correction ML model applied to two or more of: samples of the image frame, samples of previously captured image frames from the first camera, or samples from image frames from other cameras of the plurality of cameras; and performing, with the processing circuitry, post-processing based on the corrected image frame.

In one example, the disclosure describes a system for processing image data, the system comprising: memory configured to store a frame correction machine-learning (ML) model; and processing circuitry coupled to the memory and configured to: receive, with execution of the frame correction ML model, an image frame captured from a first camera of a plurality of cameras; perform, with execution of the frame correction ML model, image frame correction to generate a corrected image frame based on weights or biases of the frame correction ML model applied to two or more of: samples of the image frame, samples of previously captured image frames from the first camera, or samples from image frames from other cameras of the plurality of cameras; and perform post-processing based on the corrected image frame.

In one example, the disclosure describes one or more computer-readable storage media comprising instructions that when executed by one or more processors cause the one or more processors to: receive, with a frame correction machine-learning (ML) model executing on the one or more processors, an image frame captured from a first camera of a plurality of cameras; perform, with the frame correction ML model executing on the one or more processors, image frame correction to generate a corrected image frame based on weights or biases of the frame correction ML model applied to two or more of: samples of the image frame, samples of previously captured image frames from the first camera, or samples from image frames from other cameras of the plurality of cameras; and perform post-processing based on the corrected image frame.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle according to techniques of this disclosure.

FIG. 2 is a conceptual diagram illustrating training of a frame correction machine learning (ML) model.

FIG. 3 is a conceptual diagram illustrating an example of execution of a frame correction ML model.

FIG. 4 is a flowchart illustrating an example method of classifying an image frame.

FIG. 5 is a flowchart illustrating an example method of generating a corrected image frame.

FIG. 6 is a flowchart illustrating an example method of training a frame correction ML model.

### DETAILED DESCRIPTION

In autonomous driving (AD) systems, autonomous driving assistance systems (ADAS), or other systems used to partially or fully autonomously control a vehicle, cameras of the vehicle capture image frames that processing circuitry processes for various post-processing purposes such as generating bird's-eye-view (BEV) image content, performing object detection, or performing path planning as a few examples. However, there may be instances where there is degradation in the image frame, such that the image content of the image frame is unreliable or unusable for performing the post-processing. For example, there may be a fault in a camera, or there may be external factors such as bad lighting, bright sun, haze or fog, or occlusion of a sensor of the camera.

This disclosure describes machine learning (ML) based techniques to correct a degraded image frame. In this disclosure, the term “machine learning” is used generically to refer to systems that learn and adapt. For instance, machine learning is used generically to refer to artificial intelligence (AI), neural network, the various types of neural networks (e.g., convolutional neural network, feed forward neural network, etc.), and machine learning techniques used for image generation, such as neural radiance fields (NeRF) neural networks. Moreover, the example techniques may utilize various techniques for training, such as generative adversarial network (GAN) or PatchGAN. The use of the term machine learning model or ML model includes the various trained models that are generated using the example ML techniques, and the techniques should not be considered limited to the above examples. Also, the training of the ML model may be performed by example techniques such as GAN or PatchGAN, but the techniques should not be considered limited.

In accordance with one or more examples, the processing circuitry executes a frame correction ML model. The input to the frame correction ML model includes the image frame (e.g., degraded image frame), as well as one or more contextual information (sometimes also referred to as “priors”). Example of the contextual information includes one or more previously captured image frames from the camera that captured the degraded image frame, and one or more image frames from other cameras of the vehicle. The one or more image frames from other cameras may be image frames that at least partially overlap the degraded image frame (e.g., there is overlapping image content). Additional example of the contextual information includes depth data (e.g., as captured by LiDAR or other depth sensors), and satellite images based on global positioning system (GPS) coordinates of the vehicle.

The output from the frame correction ML model is the corrected image frame. The frame correction ML model may perform inpainting, hallucinating, or some other operation to generate the corrected image frame. For example, the frame correction ML model may determine what a value (e.g., color value, opacity value, etc.) of a sample (e.g., pixel) in the image frame should be, and update the sample in the image frame with the determined value to generate the corrected image frame. The updating of the sample in the image frame with the determined value may include replacing the value of the sample with the determined value, averaging the value of the sample with the determined value, or some other operation.

In some examples, the frame correction ML model also outputs a confidence value indicative of confidence of accuracy of the corrected image frame. The accuracy of the corrected image frame is a measure of how similar the image content of the corrected image frame is to the image content being captured by the camera if the conditions that caused the degradation were not present. Stated another way, the confidence value may be indicative of the reliability of relying on the corrected image frame for performing post-processing.

As one example, the processing circuitry may input the degraded image frame and the one or more (e.g., two or more) contextual information into the frame correction ML model multiple times to generate multiple corrected image frames. The processing circuitry may determine a variance in samples of the multiple corrected image frames to determine a confidence value (e.g., the smaller the variance, the more confidence that the corrected image frames accurately represent image content, and the higher the variance, the less confidence that the corrected image frames accurately represent image content). There may be other ways to determine the confidence value, and the techniques are not limited to specific ways in which to determine the confidence value.

For post-processing (e.g., generating BEV image content, performing object detection, or performing path planning, etc.), the processing circuitry may utilize the confidence value. For example, if the confidence value indicates high confidence in accuracy, the processing circuitry use the corrected image frame for post-processing. If the confidence value indicates low confidence in accuracy, the processing circuitry may skip use of the corrected image frame for post-processing.

In some examples, the confidence value indicative of confidence of accuracy of the corrected image frame may be a per-sample or group-of-sample confidence value. That is, each sample or group of samples (e.g., cluster of samples) may have an associated confidence value. For post-processing, the processing circuitry may use samples or groups of samples having confidence values indicative of high confidence of accuracy (e.g., confidence values are greater than a threshold value), and skip use of samples or groups of samples having confidence values indicative of low confidence of accuracy (e.g., confidence values are less than a threshold value).

As another example, for post-processing, the processing circuitry may determine if the confidence value is greater than a threshold value. If the confidence value is greater than the threshold value, the processing circuitry may use the corrected image frame in the same way that the processing circuitry would use an image for which no correction is applied. However, if the confidence value is less than the threshold value, the processing circuitry may revert to a default setting where an image frame is unavailable. For instance, if the image frame is determined to be unavailable, the processing circuitry may trigger a warning for the driver that the vehicle cannot perform autonomous driving, such as for a level three autonomous driving system.

As described, the frame correction ML model generates a correct image frame from a degraded image frame. In one or more examples, whether the processing circuitry executes the frame correction ML model or not can be selected. For instance, the processing circuitry may execute a classifier ML model that classifies image frames into at least one of no degradation or partial degradation. In some examples, the classifier model may classify image frames into no degradation, partial degradation, or full degradation.

For image frames classified as no degradation, the processing circuitry may bypass execution of the frame correction ML model. For image frame classified as having partial degradation and/or full degradation, the processing circuitry may execute the frame correction ML model to generate corrected image frames. However, in some examples, for image frames classified as full degradation, the degradation is at such a level that frame correction ML model may not be able to correct for the degradation. In such examples, the processing circuitry may bypass execution of the frame correction ML model, and instead output a null frame or some other message that indicates that the image frame is not available.

In one or more examples, the classifier ML model may generate a reliability weight for image frames classified as partial degradation and/or full degradation (if applicable). The reliability weight may be indicative of how reliable the degraded image frame is (e.g., how degraded the frame is), and the frame correction ML model may use the reliability weight as another example of contextual information for generating the corrected image frame. For instance, the reliability weight may control the amount that each of the contextual information contribute towards generating the corrected image frame. As one example, if the reliability weight indicates that the frame is highly degraded, the frame correction ML model may weight the depth information more heavily. If the reliability weight indicates that the frame is minimally degraded, the frame correction ML model may not use any depth information. Other ways in which to use the reliability weight are possible.

There may be various ways in which to determine a reliability weight. As one example, the classifier ML model may determine which samples in an image frame are corrupted. The classifier ML model may not then determine a percentage of corrupted samples in an image frame. As another examples, the classifier ML model may be use neural network based techniques to determine the reliability weight, such as based on training data that was used to train the classifier ML model and the reliability weight information the classifier ML model generated during training.

For ease of description, the techniques for classifying an image frame into no degradation, partial degradation, and/or full degradation are described as being performed with a classifier ML model. However, it may be possible to use non-ML techniques to classify image frames, including using fixed-function circuitry or non-ML based software.

The frame correction ML model may be a run-time updateable frame correction ML model. That is, the processing circuitry may be configured to update the frame correction ML model based on images that are captured while the vehicle is in motion.

As an example, at the beginning of operation of the vehicle (e.g., for a trip somewhere), the processing circuitry may execute an instance of the frame correction ML model. The sophistication of this instance of frame correction ML model may be based on various factors. For instance, this instance of frame correction ML model may be a default model. As another example, this instance of frame correction ML model may be based on images captured by other vehicles, and periodically updated by the vehicle manufacturer. As another example, this instance of frame correction ML model may be based on previous times when this particular vehicle was in use. Various combinations to have a first instance of the frame correction ML model is possible.

During operation of the vehicle, among image frames that are classified as no degradation, the processing circuitry may select (e.g., randomly) one of the image frames, and corrupt (e.g., by adding random noise) samples of the selected image frame. The uncorrupted selected image frame may be referred to as a ground truth image frame. For training, the processing circuitry may input the corrupted image frame, as well as one or more (e.g., two or more) of the contextual information (e.g., “priors”) into the first instance of the frame correction ML model, and generate a first corrected image frame. The processing circuitry may compare the first corrected image frame to the ground truth image frame. The result of the comparison may be a loss function. The processing circuitry may update weights of the first instance of the frame correction ML model based on the loss function to minimize the loss function. The updated frame correction ML model may be a second instance of the frame correction ML model.

When an image frame is classified (e.g., by the classifier ML model) as having partial and/or full degradation, the processing circuitry may execute the second instance of the frame correction ML model to generate the corrected image frame. In one or more examples, the processing circuitry may continuously, periodically, or when certain conditions are met (e.g., when processing time is available) update instances of the frame correction ML model. That is, the processing circuitry may continuously, periodically, or when certain conditions are met train the frame correction ML model. For example, if there are no image frames that are classified as having partial and/or full degradation, the processing circuitry may use one of the frames to update the training of the frame correction ML model.

In this way, the example techniques provide a practical application for image processing that can improve post-processing techniques (e.g., for autonomous driving). For instance, the example techniques may correct for image degradation for better overall operation that can be completed within less than a minute, or even less than a second, which processing a large amount of information. For example, the techniques may correct for image degradation in run-time of the vehicle moving, such as within 100 milliseconds, 200 milliseconds, or 500 milliseconds.

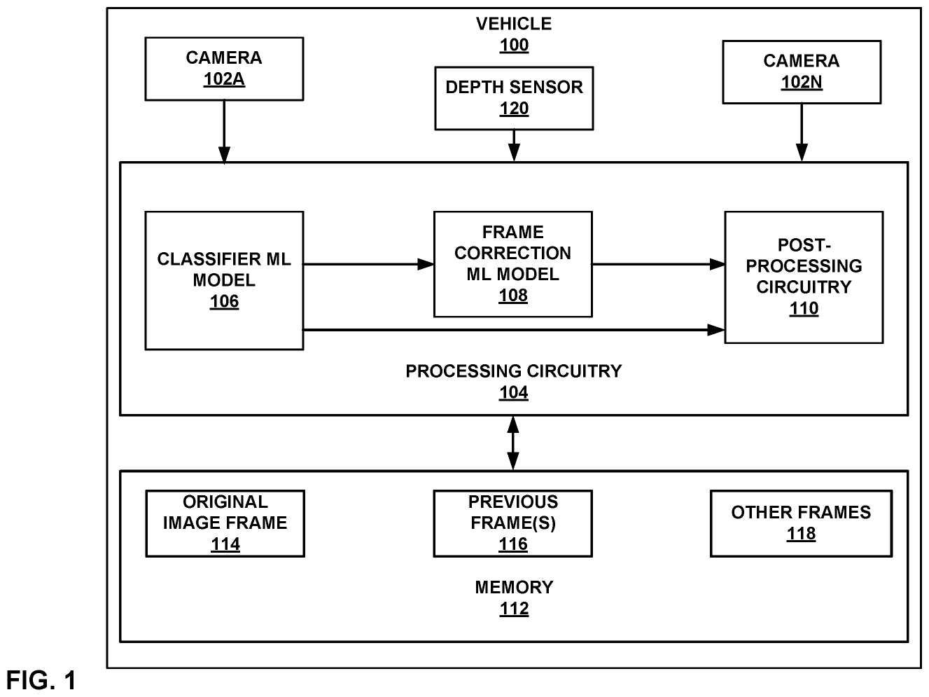

FIG. 1 is a block diagram illustrating an example vehicle 100 according to techniques of this disclosure. In this example, vehicle 100 includes cameras 102A-102N, processing circuitry 104, memory 112, and depth sensor 120. Processing circuitry 104 may be configured to execute classifier ML model 106 and frame correction ML model 108. For ease of illustration, processing circuitry 104 is shown as including post-processing circuitry 110. Post-processing circuitry 110 may be fixed-function processing circuitry or programmable circuitry configured to perform the post-processing techniques described in this disclosure.

Processing circuitry 104 may be formed in one integrated circuit (IC) or formed across may different ICs. Processing circuitry 104 may be located completely within vehicle 100, as illustrated, or distributed between different components (e.g., servers in a cloud, etc.). For ease of description only, processing circuitry 104 is described as being part of vehicle 100. However, processing circuitry 104 should not be considered as being limited to examples where processing circuitry 104 is wholly or partially included in vehicle 100.

Processing circuitry 104 may be implemented as one or more microprocessors, digital signal processors (DSPs), application specific integrated circuits (ASICs), field programmable gate arrays (FPGAs), discrete logic, software, hardware, firmware or any combinations thereof. Processing circuitry 104 may include arithmetic logic units (ALUs), elementary function units (EFUs), digital circuits, analog circuits, and/or programmable cores, formed from programmable circuits. In examples where the operations of processing circuitry 104 are performed using software (e.g., ML models) executed by the programmable circuits, memory 112 may store the instructions (e.g., object code) of the software that processing circuitry 104 receives and executes, or another memory (not shown) may store such instructions.

There may be a plurality of cameras 102A-102N (collectively cameras 102), but more or fewer cameras, including only one camera is possible. In some examples, multiple cameras 102 may be employed that face different directions, e.g., front, back, and to each side of vehicle 100. Post-processing circuitry 110 may utilize the image frames captured by cameras 102 for generating BEV image content, object detection, and/or path planning, such as in examples where vehicle 100 is part of an autonomous driving (AD) system, autonomous driving assistance system (ADAS), or other system used to partially or fully autonomously control vehicle 100.

Memory 112 may be formed by any of a variety of memory devices, such as dynamic random access memory (DRAM), including synchronous DRAM (SDRAM), magnetoresistive RAM (MRAM), resistive RAM (RRAM), ROM, EEPROM, or other types of memory devices. Memory 112 may store object code of classifier ML model 106 and frame correction ML model 108 that processing circuitry 104 retrieves and executes. Memory 112 may also store original image frame 114, previous frames(s) 116, and other frame(s) 118, as described in more detail.

Depth sensor 120 may be configured to determine the distance an object is from vehicle 100. For instance, depth sensor 120 may be a LiDAR sensor, or other types of depth sensors such as Time of Flight (ToF) sensor. The use of depth sensor 120 is not necessary for all techniques.

As described above, post-processing circuitry 110 may be configured to perform downstream processing on the image frames that cameras 102 capture. However, there may be instances where there is degradation in the image frame captured from one of cameras 102. For example, one of cameras 102 may be faulty or the image frame captured form one of cameras 102 is not usable because of external factors. One of cameras 102 may generate an image frame that is not usable because of external factors such as bad lighting, bright sun, haze or fog, or something getting stuck to the camera.

According to the techniques of this disclosure, frame correction ML model 108 may be a plug-in model that can correct for errors in an image frame due to faulty behavior of one of cameras 102 or due to external factors. For instance, frame correction ML model 108 may be pluggable into existing image processing pipelines without needing to redesign the image processing pipelines.

Classifier ML model 106 may be configured to classify image frames into at least one of no degradation or partial degradation, or into one of no degradation, partial degradation, or full degradation. Since an image frame that is fully degraded is at least partially degraded, unless specified otherwise, a partially degraded image frame includes examples of a fully degraded image frame. However, in one or more examples, classifier ML model 106 may separately label an image frame as partially degraded or fully degraded.

Classifier ML model 106 may have been trained with training a dataset that includes image frames with no degradation, partial degradation, and full degradation as ground truths. In some examples, rather than using an ML model, like classifier ML model 106, for classifying image frames, processing circuitry 104 may execute classifier software that is configured to classify image frames as no degradation, partial degradation, and/or full degradation without any learning. In some examples, fixed-function circuitry configured to classify image frames may be used. For case of description, the techniques are described with respect to classifier ML model 106, but non-machine learning based techniques are also possible.

Also, the use of classifier ML model 106, or any classifying technique, is optional. That is, it may be possible to perform the example techniques described in this disclosure without having classifier ML model 106, or any other classifying circuitry or software that classifies image frames as no degradation, partial degradation, or full degradation.

As illustrated, memory 112 stores original image frame 114. Original image frame 114 may be an image captured from one of cameras 102. For ease of description, camera 102A is described as the camera that captured image frame 114 (e.g., camera 102A is a first camera of a plurality of cameras 102). Classifier ML model 106, if applicable, receives original frame 114 from memory 112, and classifies original frame 114 as no degradation or partial degradation, or no degradation, partial degradation, or full degradation. For image frames that classifier ML model 106 determines as having no degradation, processing circuitry 104 may bypass the execution of frame correction ML model 108, and post-processing circuitry 110 may receive frames classified as having no degradation for downstream processing.

For image frames that classifier ML model 106 determines as having degradation (e.g., partial and in some cases partial or full), frame correction ML model 108 receives those image frames classified as having partial or full degradation. In some examples, for image frames having full degradation, processing circuitry 104 may bypass the execution of frame correction ML model 108, and instead output a null frame to post-processing circuitry 110 or otherwise instruct post-processing circuitry 110 to perform actions without the use of the image frame classified as being fully degraded. In examples where classifier ML model 106, or other classifying techniques, are not used, frame correction ML model 108 may receive original frame 114.

In some examples, for image frames that classifier ML model 106 classifies as having partial degradation, classifier ML model 106 may generate a reliability weight indicative of a level of degradation. For example, the training dataset used to train classifier ML model 106 may also include labels for the training image frames that indicate a level of degradation of training image frames. In some examples, as part of the training for classification, classifier ML model 106 may also be trained to indicate a reliability weight that indicates the level of degradation.

Frame correction ML model 108 may utilize the reliability weight from classifier ML model 106, if available or needed, original image frame 114 (e.g., having partial degradation), and one or more contextual information (also called “priors”) to generate a corrected image frame. The contextual information includes information that can assist in image frame correction. For instance, the reliability weight from classifier ML model 106 is one example of contextual information. Another example of contextual information includes previous frames 116. Previous frames 116 refer to previously captured image frames from the camera that captured original image frame 114 (e.g., camera 102A). For instance, previous frames 116 may be “n” previous frames captured from camera 102A before the frame that classifier ML model 106 determined was degraded. Another example of contextual information is other frames 118, which are frames from cameras other than camera 102A that captured image frame 114. For instance, there may be overlap in image content captured from camera 102A and another one of cameras 102. Other frames 118 include such image frames from cameras 102 other than camera 102A. That is, at least some of the samples from image frames 118 from the other cameras overlap with at least some of the samples of the image frame 114 from the camera 102A. It may not be required that other frames 118 include image content that overlaps with image frame 114.

Other frames 118 and previous frames 116 may be together referred to as “spatial-temporal” priors or contextual information. For example, other frames 118 may capture more spatial content, with possibly some overlap, as image frame 114. Previous frames 116 may be frames captured from camera 102A that temporally precede the frame determined to be degraded. Accordingly, previous frames 116 may be “n” previous frames stored in a buffer in memory 112 that can be used to provide information about the environment until a degraded image frame 114 is generated. Also, since there are multiple onboard cameras 102 that are observing the same environment, the overlap from cameras may assist in generating the corrected image frame.

In some examples, contextual information may include depth data from depth sensor 120. As another example, if available, contextual information includes satellite images such as based on global positioning system (GPS) coordinates of vehicle 100.

The above includes examples of contextual information. However, the example techniques should not be considered limited to the above examples. Furthermore, not all of the example contextual information may be needed by frame correction ML model 108, and frame correction ML model 108 may use more, fewer, or different contextual information for generating a corrected image frame.

In general, the contextual information may be information that can be useful in generating the corrected image frame. For example, while vehicle 100 is in motion, previous frames 116 may provide a way to estimate the sample values in the degraded image frame 114. If the capture rate of camera 102A is sufficiently high, the amount of image content that changes from frame-to-frame may be less, and therefore, previous frames 116 may function well as contextual information. As another example, because cameras 102, such as those that are proximate to camera 102A and aligned in same direction as camera 102A, may capture similar image content, other frames 118 may function well as contextual information for correcting image frame 114.

As another example, depth data from depth sensor 120 may also assist frame correction ML model 108 to hallucinate structure of the scene captured by image frame 114. For example, the sharpness of image content may be based on how close or far an object in the image content is. By using depth data, frame correction ML model 108 may be able to determine sample values for objects that are closer to have more sharpness than sample values for objects that are further in the background.

Frame correction ML model 108 may be a machine learning model having a plurality of neurons that are at different layers. Weights or biases of frame correction ML model 108 may control the signal (e.g., strength of the connection) between neurons. For instance, frame correction ML model 108 may convert original image frame 114 into a vector or matrix based on sample values (e.g., pixel values) of image frame 114 that can be fed into the layers of frame correction ML model 108. In addition, frame correction ML model 108 may convert the contextual information into values useable by the layers of frame correction ML model 108. In this way, original image 114 and the contextual information may form as inputs to frame correction ML model 108.

During training of frame correction ML model 108, described in more detail below, the circuitry performing the training (e.g., processing circuitry 104 or some other circuitry, such as in servers in a cloud infrastructure) may determine weight or biases (e.g., determine one or both of the weights and biases) for frame correction ML model 108 using training datasets. Frame correction ML model 108 may then apply the weights or biases (e.g., apply one or both of the weights and biases) determined as part of the training to samples of image frame 114 and other contextual information (e.g., samples of previously captured image frames, such as previous frames 116, or samples from image frames from other cameras, such as other frames 118).

The output from frame correction ML model 108, based on applying the weights or biases to image frame 114 and the contextual information, may be a corrected image frame. For instance, in the corrected image frame, one or more samples are different than one or more samples in image frame 114. As one example, through the layers of frame correction ML model 108, frame correction ML model 108 updates the sample values (e.g., color, opacity, etc.) of at least some samples in image frame 114. As one example, based on the paths through the frame correction ML model 108, the application of the weights or biases causes frame correction ML model 108 to determine updated values for samples in image frame 114. Frame correction ML model 108 may replace the samples values with the updated sample values, average the sample values with the updated sample values, or some other process. This process of updating sample values (e.g., replace, average, etc.) may be referred to as inpainting, repairing, or hallucinating samples.

In this way, frame correction ML model 108 executing on processing circuitry 104 may perform image frame correction to generate corrected image frame based on weights or biases of frame correction ML model 108 applied to one or more (e.g., two or more) of: samples of the image frame 114, samples of previously captured image frames from the camera (e.g., previous frames 116), or samples from image frames from other cameras (e.g., other frames 118). In some examples, to perform image frame correction, frame correction ML model 108 may perform the image frame correction to generate the corrected image frame based on the weights or biases of frame correction ML model 108 applied to one or more (e.g., two or more) of: the samples of the image frame 114, the samples of previously captured image frames from the camera (e.g., previous frames 116), the samples from image frames from other cameras (e.g., other frames 118), depth data (e.g., from depth sensor 120), or samples of a satellite image frame.

Frame correction ML model 108 may also use the reliability weight from classifier ML model 106. The reliability weight may control the amount that each of the contextual information contribute towards generating the corrected image frame. As an example, the weights or biases of frame correction ML model 108 may be such that depth data from depth sensor 120 is weighted more heavily for high level of degradation, and depth data from depth sensor 120 is weighted less heavily for low level of degradation.

There is possibility that the corrected image frame does not completely accurate in representing the image content if there was no degradation. In one or more examples, frame correction ML model 108 may also be configured to generate a confidence value indicative of confidence of accuracy of the corrected image frame. The confidence value may be indicative the quality of the samples of image frame 114 whose values were replaced (e.g., painted, updated, etc.) with frame correction ML model 108.

As one example, processing circuitry 104 may execute frame correction ML model 108 multiple times with image frame 114 and the contextual information as inputs. If there is high sample value variance in the corrected images, then frame correction ML model 108 may determine that there is low confidence in accuracy, but if there is low sample value variance in the corrected images, then frame correction ML model 108 may determine that there is high confidence in accuracy. There may be other ways to determine the confidence value, and the techniques are not limited the examples.

The confidence value may be for the entire corrected frame or may be one value in a plurality of values that form a confidence map. For instance, in the confidence map, each sample (e.g., pixel) or group of samples (e.g., group of pixels) may have an associated confidence value (e.g., based on the variance of that sample or group of samples).

Post-processing circuitry 110 may be configured to perform post-processing based on the corrected image frame. In examples where frame correction ML model 108 generates a confidence value (e.g., for the whole corrected image frame, on a sample-by-sample basis, or group of samples-by-group of samples basis), post-processing circuitry 110 may use the confidence value to perform post-processing. For example, post-processing circuitry 110 may generate bird's-eye-view (BEV) image content based on the corrected image frame, perform object detection based on the corrected image frame, or perform path planning for vehicle 100 based on the corrected image frame.

In some examples, post-processing circuitry 110 may use samples or groups of samples having confidence values indicative of high confidence of accuracy, and skip use of samples or groups of samples having confidence values indicative of low confidence of accuracy. For example, for path planning through a street, if the corrected image frame or samples of the corrected image frame have low confidence of accuracy based on the confidence value (e.g., confidence value less than a threshold value), then post-processing circuitry 110 may not use those sample values for path planning. As another example, if the corrected image frame or samples of the corrected image frame have high confidence of accuracy based on the confidence value (e.g., confidence value greater than the threshold value), then post-processing circuitry 110 may determine contours in the corrected image frame to identify objects.

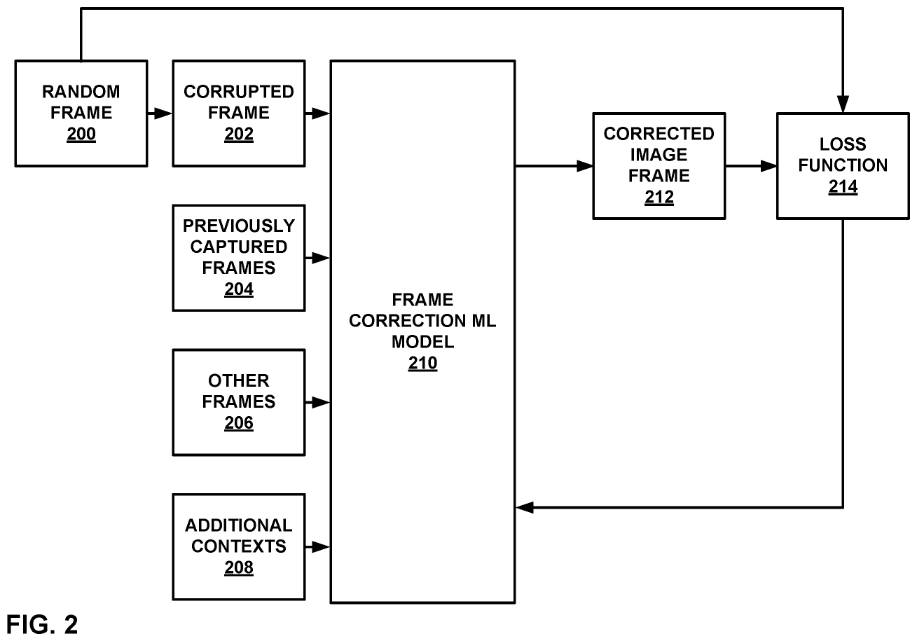

FIG. 2 is a conceptual diagram illustrating training of a frame correction machine learning (ML) model. FIG. 2 illustrates an example of training frame correction ML model 210. Frame correction ML model 210 may be a first instance of frame correction ML model 108 of FIG. 1.

For instance, at the time that vehicle 100 is manufactured or after vehicle 100 is manufactured, the manufacturer of vehicle 100 may load frame correction ML model 210 into memory 112 for execution by processing circuitry 104. In this example, initially ML model 210 may be a default ML model. The default ML model may be untrained with default weights or biases (e.g., one or both of default weights and biases). In some examples, rather than loading a default ML model, the manufacturer may load frame correction ML model 210 that has been trained with images captured by vehicles other than vehicle 100. In some examples, frame correction ML model 210 may have been previously trained during the previous time that vehicle 100 was driven.

In one or more examples, during operation of vehicle 100, processing circuitry (e.g., processing circuitry 104 or some other processing circuitry) may be configured to during run-time, while driving, use the ever-present captured images from cameras 120 to train frame correction ML model 210 until there is an image with degradation. For case, the example techniques are described with respect to processing circuitry 104.

In some examples, frame correction ML model 210 may be a PatchGAN-style network or a Nerf-based view generation network. As described in more detail, as one example, processing circuitry 104 may train the GAN online (e.g., while vehicle 100 is driving) in parallel to the deployed network (e.g., while frame correction ML model 210 is ready to perform image frame correction if needed) when the perspective view images are available (e.g., image frames from cameras 102 are available) by intentionally corrupting one of the perspective view images. In general, for training, processing circuitry 104 may treat the corruption as an adversarial attack on the image frame, and train a GAN to inpaint the missing or corrupted pixels. Then in operation, frame correction ML model 108 may treat degradation generated by external factors or lighting conditions as an adversarial attack that frame correction ML model 108 can correct.

For instance, as illustrated in FIG. 2, processing circuitry 104 may select a random image frame 200. Random image frame 200 may be any one of the image frames from cameras 102 that has not been classified by classifier ML model 106 as having degradation. For reasons below, random image frame 200 may also be considered as ground truth image frame 200. For purposes of example, assume that random image frame 200 is a frame from camera 102B. In some examples, the training of frame correction ML model 210 may be while no frames from any of cameras 102 have been classified as having degradation.

Processing circuitry 104 may generate corrupted image frame 202 from random image frame 200. As one example, processing circuitry 104 may use a black-box random noise model to corrupt random image frame 200 to generate corrupted image frame 202. Other ways to corrupt random image frame 200 are possible.

As illustrated, frame correction ML model 210 may receive as input corrupted image frame 202, previously captured frames 204 (e.g., frames previously captured from camera 102B), other frames (e.g., frames from cameras other than camera 102B), and additional contexts 208 (e.g., depth data and satellite images, or other types of contextual information). From these inputs, frame correction ML model 210 may generate corrected image frame 212.

In this example, corrected image frame 212 should be similar to random image frame 200. Because random image frame 200 is a known frame without degradation, random image frame 200 is a ground truth image frame 200 against which processing circuitry 104 can compare corrected image frame 212. For example, loss function 214 may generate a ground truth confidence score based on the comparison of random image frame 200 to corrected image frame 212. The ground truth confidence score may be fed back into frame correction ML model 210 to update the weights or biases (e.g., one or both of weights and biases) of frame correction ML model 210. That is, processing circuitry 104 may keep performing this feedback process with new random image frames 200 and updating of weights or biases of frame correction ML model 210 to minimize the loss (e.g., maximize ground truth confidence score).

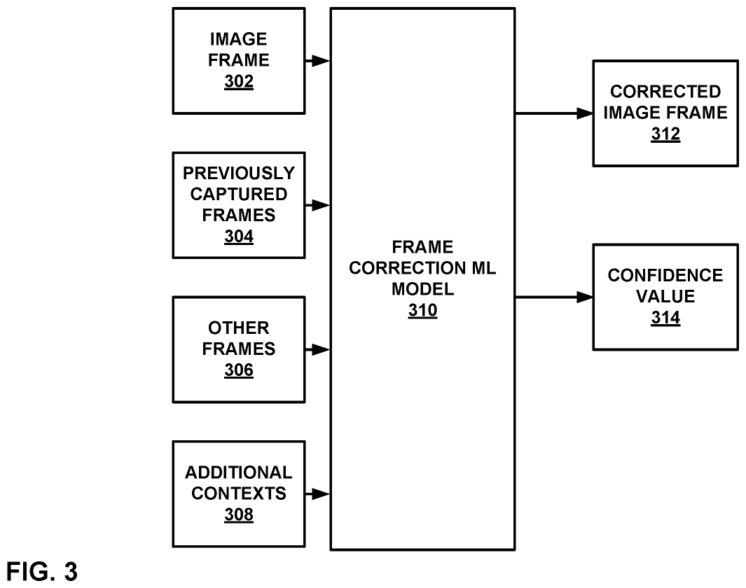

In this way, during operation of vehicle 100, processing circuitry 100 may update a first instance of the frame correction ML model (e.g., frame correction ML model 210) to generate a second, updated instance of the frame correction ML model (e.g., frame correction ML model 108 of FIG. 1 or frame correction ML model 310 of FIG. 3, described below). For example, processing circuitry 104 may corrupt a ground truth image frame (e.g., random image frame 200) captured with one of the cameras of the vehicle 100 before the camera captured an image frame degradation to generate a corrupted image frame 202.

Processing circuitry 104 may apply the first instance of the frame correction ML model (e.g., frame correction ML model 210) to the corrupted image frame 202 to generate a corrected image frame 212. Processing circuitry 104 may compare the corrected image frame 212 and the ground truth image frame 200, and update weights or biases (e.g., update one or both of the weights and biases) of the first instance of the frame correction ML model (e.g., frame correction ML model) based on the comparison of the corrected image frame 212 and the ground truth image frame 200 to generate the second, updated instance of the frame correction ML model (e.g., frame correction ML model 210 of FIG. 1 or frame correction ML model 310 of FIG. 3).

FIG. 3 is a conceptual diagram illustrating an example of execution of a frame correction ML model. For instance, FIG. 3 illustrates frame correction ML model 310, which may be considered as a second instance of the frame correction ML model that is generated based on the updating (e.g., during operation of vehicle 100) of the first instance of the frame correction ML model (e.g., frame correction ML model 210).

In the example of FIG. 3, image frame 302, captured from camera 102A, may have partial degradation. Frame correction ML model 310 may receive image frame 302 captured from camera 102A of vehicle 100. Frame correction ML model 310 may perform image frame correction to generate corrected image frame 312 based on weights or biases of the frame correction ML model 310 applied to one or more of: samples of the image frame 302, samples of previously captured image frames from the camera (e.g., previously captured frames 304 from camera 102A), or samples from image frames from other cameras 102 (e.g., other frames 306).

Frame correction ML model 310 may optionally include additional contexts 308 such as depth data from depth sensor 120, satellite images, and/or reliability weight from classifier ML model 106 that classified image frame 302 as having partial degradation. For example, frame correction ML model 310 may perform the image frame correction to generate the corrected image frame 312 based on the weights or biases of the frame correction ML model applied to one or more of: the samples of the image frame 302, the samples of previously captured image frames from the camera (e.g., previously captured frames 304), the samples from image frames from other cameras (e.g., other frames 306), depth data, or samples of a satellite image frame (e.g., additional contexts 308). As another example, frame correction ML model 310 may perform image frame correction to generate corrected image frame 312 based on weights or biases of the frame correction ML model 310 applied to one or more of: samples of the image frame 302, samples of previously captured image frames from the camera (e.g., previously captured frames 304), or samples from image frames from other cameras (e.g., other frames 306), and further based on the reliability weight generated by classifier ML model 106.

In one or more examples, frame correction ML model 310 may also generate confidence value 314 indicative of confidence of accuracy of corrected image frame 312. Confidence value 314 may be the overall confidence value of corrected image frame 312 or may be a confidence value of a sample or group of samples of corrected image frame 312, as part of a confidence map.

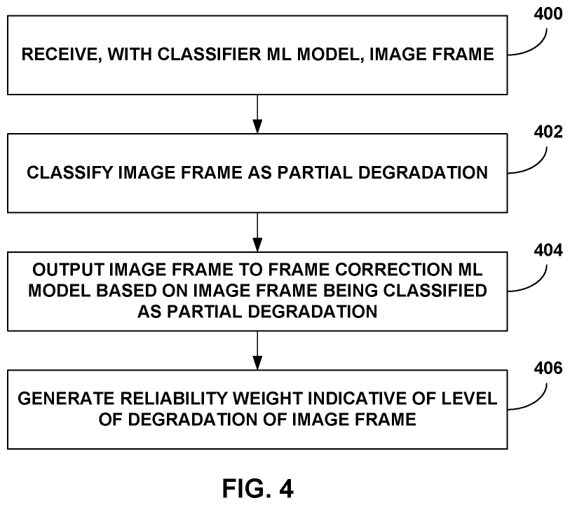

FIG. 4 is a flowchart illustrating an example method of classifying an image frame. For ease of description, the example of FIG. 4 is described with respect to processing circuitry 104 performing the example techniques, but other processing circuitry in addition to or instead of processing circuitry 104 may perform the example techniques. Reference is also made to FIG. 1. Also, the example of FIG. 4 may not be necessary in all examples, such as in examples where classifying frames as no degradation, partial degradation, and/or full degradation is not necessary.

Prior to the frame correction ML model 108 receiving image frame 114, classifier ML model 106, executing on processing circuitry 104, may receive the image frame 114 (400). As described, the classifier ML model 106 may be configured to classify image frames into at least one of having no degradation or partial degradation.

In this example, classifier ML model 106 may classify the image frame 114 as partial degradation (402). However, it may be possible that in some examples classifier ML model 106 classifies image frame 114 as no degradation or full degradation. Classifier ML model 106 may output image frame 114 to the frame correction ML model 108 based on image frame 114 being classified as partial degradation (404). For instance, if image frame 114 were classified as no degradation, and in some cases, as full degradation, classifier ML model 106 may bypass frame correction ML model 108.

Classifier ML model 106 may generate a reliability weight indicative of a level of degradation of the image frame 114 (406). Generation of the reliability weight is not necessary in all examples, but may be used by frame correction ML model 108 for image frame correction.

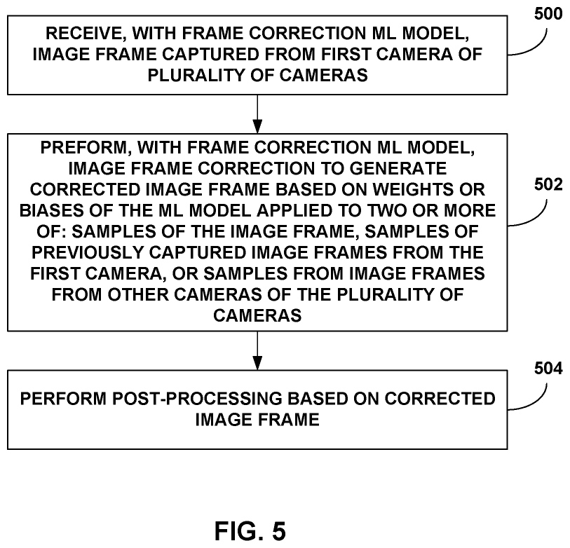

FIG. 5 is a flowchart illustrating an example method of generating a corrected image frame. For ease of description, the example of FIG. 5 is described with respect to processing circuitry 104 performing the example techniques, but other processing circuitry in addition to or instead of processing circuitry 104 may perform the example techniques. The example techniques may be performed by frame correction ML model 108 of FIG. 1 or frame correction ML model 310 of FIG. 3, and post-processing circuitry 110. For ease, the examples are described with respect to frame correction ML model 310.

Frame correction ML model 310 executing on processing circuitry 104 may receive an image frame 302 captured from a first camera of a plurality of cameras 102 (e.g., camera 102A) of vehicle 100 (500). In this example, assume that image frame 302 is at least partially degraded.

Frame correction ML model 310 may perform image frame correction (e.g., perform inpainting on image frame 302) to generate a corrected image frame 312 based on weights or biases (e.g., one or both of weights and biases) of the frame correction ML model 310 applied to two or more of: samples of the image frame 302, samples of previously captured image frames from the first camera (e.g., previously captured frames 304), or samples from image frames from other cameras of the plurality of cameras (e.g., other frames 306) (502). In some examples, at least some of the samples from the image frames (e.g., other frames 306) from the other cameras (e.g., other than camera 102A) overlap with at least some of the samples of the image frame 302 from the camera 102A.

In some examples, frame correction ML model 310 may perform image frame correction based on additional contexts 308. For example, frame correction ML model 310 may perform image frame correction to generate corrected image frame 312 based on the weights or biases of the frame correction ML model 310 applied to two or more of: the samples of the image frame 302, the samples of previously captured image frames from the first camera (e.g., previously captured frames 304), the samples from image frames from other cameras (e.g., other frames 304), depth data from depth sensor 120, or samples of a satellite image frame. As another example, frame correction ML model 310 may perform image frame correction to generate corrected image frame 312 based on the weights or biases of the frame correction ML model 310 applied to two or more of: the samples of the image frame 302, the samples of previously captured image frames from the first camera (e.g., previously captured frames 304), or the samples from image frames from other cameras (e.g., other frames 304), and further based on the reliability weight generated by classifier ML model 106.

Post-processing circuitry 110 may perform post-processing based on the corrected image frame 312 (504). In some examples, frame correction ML model 310 may generate confidence value 314. Post-processing circuitry 110 may be configured to perform post-processing based on the corrected image frame 312 and the confidence value 314. In some examples, post-processing circuitry 110 may generate bird's-eye-view image content based on the corrected image frame 312, perform object detection based on the corrected image frame 312, or perform path planning based on the corrected image frame 312.

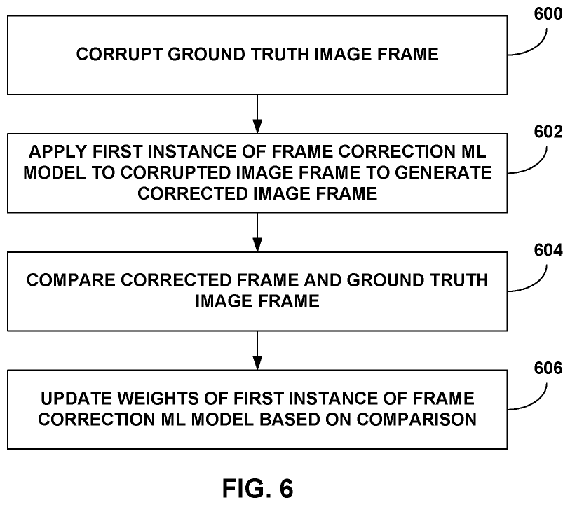

FIG. 6 is a flowchart illustrating an example method of training a frame correction ML model. For ease of description, the example of FIG. 6 is described with respect to processing circuitry 104 performing the example techniques, but other processing circuitry in addition to or instead of processing circuitry 104 may perform the example techniques. The example techniques may be performed frame correction ML model 210 as part of training. For instance, during operation of vehicle 100, processing circuitry 104 may be configured to update a first instance of the frame correction ML model 210 to generate the second, updated instance of the frame correction ML model (e.g., frame correction ML model 108 of FIG. 1 or frame correction ML model 310 of FIG. 3).

Processing circuitry 104 may corrupt a ground truth image frame (e.g., image frame 200) captured with one of the cameras 102 of vehicle 100 before or after performing the example techniques of FIG. 5 to generate corrupted image frame 202 (600). That is, the example of FIG. 6 may be performed as part of training before a degraded image frame is received or after the degraded image frame is received, such as when no image frame from cameras 102 is degraded.

Processing circuitry 104 may apply the first instance of the frame correction ML model (e.g., frame correction ML model 210) to the corrupted image frame 202 to generate a corrected image frame 212 (602). Processing circuitry 104 may compare the corrected image frame 212 and the ground truth image frame 200 (604). Processing circuitry 104 may update weights or biases (e.g., one or both of weights and biases) of the first instance of the frame correction ML model (e.g., frame correction ML model 210) based on the comparison of the corrected image frame 212 and the ground truth image frame 200 to generate the second, updated instance of the frame correction ML model (e.g., frame correction ML model 108 of FIG. 1 or frame correction ML model 310 of FIG. 3).

Various examples of the techniques of this disclosure are summarized in the following clauses:

Clause 1. A method of processing image data, the method comprising: receiving, with a frame correction machine-learning (ML) model executing on processing circuitry, an image frame captured from a first camera of a plurality of cameras; performing, with the frame correction ML model executing on the processing circuitry, image frame correction to generate a corrected image frame based on weights or biases of the frame correction ML model applied to two or more of: samples of the image frame, samples of previously captured image frames from the first camera, or samples from image frames from other cameras of the plurality of cameras; and performing, with the processing circuitry, post-processing based on the corrected image frame.

Clause 2. The method of clause 1, wherein the plurality of cameras are cameras of a vehicle.

Clause 3. The method of any of clauses 1 and 2, further comprising: generating, with the processing circuitry, a confidence value indicative of confidence of accuracy of the corrected image frame, wherein performing post-processing comprises performing post-processing based on the corrected image frame and the confidence value.

Clause 4. The method of any of clauses 1-3, wherein performing image frame correction comprises performing the image frame correction to generate the corrected image frame based on the weights or biases of the frame correction ML model applied to two or more of: the samples of the image frame, the samples of previously captured image frames from the first camera, the samples from image frames from other cameras, depth data, or samples of a satellite image frame.

Clause 5. The method of any of clauses 1-4, the method further comprising: receiving, with a classifier ML model executing on the processing circuitry, the image frame prior to the frame correction ML model receiving the image frame, wherein the classifier ML model is configured to classify image frames into at least one of having no degradation or partial degradation; classifying, with the classifier ML model executing on the processing circuitry, the image frame as partial degradation; and outputting the image frame to the frame correction ML model based on the image frame being classified as partial degradation.

Clause 6. The method of clause 5, further comprising: generating a reliability weight indicative of a level of degradation of the image frame, wherein performing image frame correction comprises performing image frame correction to generate corrected image frame based on weights or biases of the frame correction ML model applied to two or more of: samples of the image frame, samples of previously captured image frames from the first camera, or samples from image frames from other cameras, and further based on the reliability weight.

Clauses 7. The method of any of clauses 1-6, wherein the frame correction ML model comprises a second, updated instance of the frame correction ML model, the method further comprising: during operation of a vehicle that includes the plurality of cameras, updating a first instance of the frame correction ML model to generate the second, updated instance of the frame correction ML model.

Clause 8. The method of clause 7, wherein the image frame comprises a second image frame, wherein the corrected image frame comprises a second corrected image frame, and wherein updating the first instance of the frame correction ML model comprises: corrupting a ground truth image frame captured with one of the plurality of cameras before the first camera captured the second image frame to generate a corrupted image frame; applying the first instance of the frame correction ML model to the corrupted image frame to generate a first corrected image frame; comparing the first corrected image frame and the ground truth image frame; and updating weights or biases of the first instance of the frame correction ML model based on comparing the first corrected image frame and the ground truth image frame to generate the second, updated instance of the frame correction ML model.

Clause 9. The method of any of clauses 1-8, wherein performing image frame correction comprises performing inpainting on the image frame.

Clause 10. The method of any of clauses 1-9, wherein performing post-processing comprises one or more of: generating bird's-eye-view image content based on the corrected image frame; performing object detection based on the corrected image frame; or performing path planning based on the corrected image frame.

Clause 11. A system for processing image data, the system comprising: memory configured to store a frame correction machine-learning (ML) model; and processing circuitry coupled to the memory and configured to: receive, with execution of the frame correction ML model, an image frame captured from a first camera of a plurality of cameras; perform, with execution of the frame correction ML model, image frame correction to generate a corrected image frame based on weights or biases of the frame correction ML model applied to two or more of: samples of the image frame, samples of previously captured image frames from the first camera, or samples from image frames from other cameras of the plurality of cameras; and perform post-processing based on the corrected image frame.

Clause 12. The system of clause 11, wherein the plurality of cameras are cameras of a vehicle.

Clause 13. The system of any of clauses 11 and 12, wherein the processing circuitry is configured to: generate, with execution of the frame correction ML model, a confidence value indicative of confidence of accuracy of the corrected image frame, wherein to perform post-processing, the processing circuitry is configured to perform post-processing based on the corrected image frame and the confidence value.

Clause 14. The system of any of clauses 11-13, wherein to perform image frame correction, the processing circuitry is configured to perform, with execution of the frame correction ML model, the image frame correction to generate the corrected image frame based on the weights or biases of the frame correction ML model applied to two or more of: the samples of the image frame, the samples of previously captured image frames from the first camera, the samples from image frames from other cameras, depth data, or samples of a satellite image frame.

Clause 15. The system of any of clauses 11-14, wherein the processing circuitry is configured to: receive, with execution of a classifier ML model, the image frame prior to the frame correction ML model receiving the image frame, wherein the classifier ML model is configured to classify image frames into at least one of having no degradation or partial degradation; classify, with the execution of the classifier ML model, the image frame as partial degradation; and output the image frame to the frame correction ML model based on the image frame being classified as partial degradation.

Clause 16. The system of clause 15, wherein the processing circuitry is configured to: generate a reliability weight indicative of a level of degradation of the image frame, wherein to perform image frame correction, the processing circuitry is configured to perform, with execution of the frame correction ML model, image frame correction to generate corrected image frame based on weights or biases of the frame correction ML model applied to two or more of: samples of the image frame, samples of previously captured image frames from the first camera, or samples from image frames from other cameras, and further based on the reliability weight.

Clause 17. The system of any of clauses 11-16, wherein the frame correction ML model comprises a second, updated instance of the frame correction ML model, and wherein the processing circuitry is configured to: during operation of a vehicle that includes the plurality of cameras, update a first instance of the frame correction ML model to generate the second, updated instance of the frame correction ML model.

Clause 18. The system of clause 17, wherein the image frame comprises a second image frame, wherein the corrected image frame comprises a second corrected image frame, and wherein to update the first instance of the frame correction ML model, the processing circuitry is configured to: corrupt a ground truth image frame captured with one of the plurality of cameras before the first camera captured the second image frame to generate a corrupted image frame; apply the first instance of the frame correction ML model to the corrupted image frame to generate a first corrected image frame; compare the first corrected image frame and the ground truth image frame; and update weights or biases of the first instance of the frame correction ML model based on comparing the first corrected image frame and the ground truth image frame to generate the second, updated instance of the frame correction ML model.

Clause 19. The system of any of clauses 11-18, wherein to perform image frame correction, the processing circuitry is configure to perform, with execution of the frame correction ML model, inpainting on the image frame.

Clause 20. The system of any of clauses 11-19, wherein to perform post-processing, the processing circuitry is configured to one or more of: generate bird's-eye-view image content based on the corrected image frame; perform object detection based on the corrected image frame; or perform path planning based on the corrected image frame.

Clause 21. The system of any of clauses 11-20, further comprising a vehicle, wherein the vehicle includes the plurality of cameras, the memory, and the processing circuitry.

Clause 22. One or more computer-readable storage media comprising instructions that when executed by one or more processors cause the one or more processors to: receive, with a frame correction machine-learning (ML) model executing on the one or more processors, an image frame captured from a first camera of a plurality of cameras; perform, with the frame correction ML model executing on the one or more processors, image frame correction to generate a corrected image frame based on weights or biases of the frame correction ML model applied to two or more of: samples of the image frame, samples of previously captured image frames from the first camera, or samples from image frames from other cameras of the plurality of cameras; and perform post-processing based on the corrected image frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware. Various examples have been described. These and other examples are within the scope of the following claims.

What is claimed is:

1. A method of processing image data, the method comprising:
receiving, with a frame correction machine-learning (ML) model executing on processing circuitry, an image frame captured from a first camera of a plurality of cameras;
performing, with the frame correction ML model executing on the processing circuitry, image frame correction to generate a corrected image frame based on weights or biases of the frame correction ML model applied to two or more of: samples of the image frame, samples of previously captured image frames from the first camera, or samples from image frames from other cameras of the plurality of cameras; and
performing, with the processing circuitry, post-processing based on the corrected image frame.

2. The method of claim 1, wherein the plurality of cameras are cameras of a vehicle.

3. The method of claim 1, further comprising:
generating, with the processing circuitry, a confidence value indicative of confidence of accuracy of the corrected image frame,
wherein performing post-processing comprises performing post-processing based on the corrected image frame and the confidence value.

4. The method of claim 1, wherein performing image frame correction comprises performing the image frame correction to generate the corrected image frame based on the weights or biases of the frame correction ML model applied to two or more of: the samples of the image frame, the samples of previously captured image frames from the first camera, the samples from image frames from other cameras, depth data, or samples of a satellite image frame.

5. The method of claim 1, the method further comprising:
receiving, with a classifier ML model executing on the processing circuitry, the image frame prior to the frame correction ML model receiving the image frame, wherein the classifier ML model is configured to classify image frames into at least one of having no degradation or partial degradation;
classifying, with the classifier ML model executing on the processing circuitry, the image frame as partial degradation; and
outputting the image frame to the frame correction ML model based on the image frame being classified as partial degradation.

6. The method of claim 5, further comprising:
generating a reliability weight indicative of a level of degradation of the image frame,
wherein performing image frame correction comprises performing image frame correction to generate corrected image frame based on weights or biases of the frame correction ML model applied to two or more of: samples of the image frame, samples of previously captured image frames from the first camera, or samples from image frames from other cameras, and further based on the reliability weight.

7. The method of claim 1, wherein the frame correction ML model comprises a second, updated instance of the frame correction ML model, the method further comprising:
during operation of a vehicle that includes the plurality of cameras, updating a first instance of the frame correction ML model to generate the second, updated instance of the frame correction ML model.

8. The method of claim 7, wherein the image frame comprises a second image frame, wherein the corrected image frame comprises a second corrected image frame, and wherein updating the first instance of the frame correction ML model comprises:
corrupting a ground truth image frame captured with one of the plurality of cameras before the first camera captured the second image frame to generate a corrupted image frame;
applying the first instance of the frame correction ML model to the corrupted image frame to generate a first corrected image frame;
comparing the first corrected image frame and the ground truth image frame; and
updating weights or biases of the first instance of the frame correction ML model based on comparing the first corrected image frame and the ground truth image frame to generate the second, updated instance of the frame correction ML model.

9. The method of claim 1, wherein performing image frame correction comprises performing inpainting on the image frame.

10. The method of claim 1, wherein performing post-processing comprises one or more of:
generating bird's-eye-view image content based on the corrected image frame;
performing object detection based on the corrected image frame; or
performing path planning based on the corrected image frame.

11. A system for processing image data, the system comprising:
memory configured to store a frame correction machine-learning (ML) model; and
processing circuitry coupled to the memory and configured to:
receive, with execution of the frame correction ML model, an image frame captured from a first camera of a plurality of cameras;
perform, with execution of the frame correction ML model, image frame correction to generate a corrected image frame based on weights or biases of the frame correction ML model applied to two or more of: samples of the image frame, samples of previously captured image frames from the first camera, or samples from image frames from other cameras of the plurality of cameras; and
perform post-processing based on the corrected image frame.

12. The system of claim 11, wherein the plurality of cameras are cameras of a vehicle.

13. The system of claim 11, wherein the processing circuitry is configured to:
generate, with execution of the frame correction ML model, a confidence value indicative of confidence of accuracy of the corrected image frame,
wherein to perform post-processing, the processing circuitry is configured to perform post-processing based on the corrected image frame and the confidence value.

14. The system of claim 11, wherein to perform image frame correction, the processing circuitry is configured to perform, with execution of the frame correction ML model, the image frame correction to generate the corrected image frame based on the weights or biases of the frame correction ML model applied to two or more of: the samples of the image frame, the samples of previously captured image frames from the first camera, the samples from image frames from other cameras, depth data, or samples of a satellite image frame.

15. The system of claim 11, wherein the processing circuitry is configured to:
receive, with execution of a classifier ML model, the image frame prior to the frame correction ML model receiving the image frame, wherein the classifier ML model is configured to classify image frames into at least one of having no degradation or partial degradation;
classify, with the execution of the classifier ML model, the image frame as partial degradation; and
output the image frame to the frame correction ML model based on the image frame being classified as partial degradation.

16. The system of claim 15, wherein the processing circuitry is configured to:
generate a reliability weight indicative of a level of degradation of the image frame,
wherein to perform image frame correction, the processing circuitry is configured to perform, with execution of the frame correction ML model, image frame correction to generate corrected image frame based on weights or biases of the frame correction ML model applied to two or more of: samples of the image frame, samples of previously captured image frames from the first camera, or samples from image frames from other cameras, and further based on the reliability weight.

17. The system of claim 11, wherein the frame correction ML model comprises a second, updated instance of the frame correction ML model, and wherein the processing circuitry is configured to:
during operation of a vehicle that includes the plurality of cameras, update a first instance of the frame correction ML model to generate the second, updated instance of the frame correction ML model.

18. The system of claim 17, wherein the image frame comprises a second image frame, wherein the corrected image frame comprises a second corrected image frame, and wherein to update the first instance of the frame correction ML model, the processing circuitry is configured to:
corrupt a ground truth image frame captured with one of the plurality of cameras before the first camera captured the second image frame to generate a corrupted image frame;
apply the first instance of the frame correction ML model to the corrupted image frame to generate a first corrected image frame;
compare the first corrected image frame and the ground truth image frame; and
update weights or biases of the first instance of the frame correction ML model based on comparing the first corrected image frame and the ground truth image frame to generate the second, updated instance of the frame correction ML model.

19. The system of claim 11, wherein to perform image frame correction, the processing circuitry is configure to perform, with execution of the frame correction ML model, inpainting on the image frame.

20. The system of claim 11, wherein to perform post-processing, the processing circuitry is configured to one or more of:
generate bird's-eye-view image content based on the corrected image frame;
perform object detection based on the corrected image frame; or
perform path planning based on the corrected image frame.

21. The system of claim 11, further comprising a vehicle, wherein the vehicle includes the plurality of cameras, the memory, and the processing circuitry.

22. One or more computer-readable storage media comprising instructions that when executed by one or more processors cause the one or more processors to:
receive, with a frame correction machine-learning (ML) model executing on the one or more processors, an image frame captured from a first camera of a plurality of cameras;
perform, with the frame correction ML model executing on the one or more processors, image frame correction to generate a corrected image frame based on weights or biases of the frame correction ML model applied to two or more of: samples of the image frame, samples of previously captured image frames from the first camera, or samples from image frames from other cameras of the plurality of cameras; and
perform post-processing based on the corrected image frame.
